(19) United States
(12) Patent Application Publication
(10) Pub. No.: US 2026/0366431 A1
(43) Pub. Date: Nov. 19, 2026

(54) ENGINE BLADE WITH INTEGRATED HEATING ELEMENT

(71) Applicant: LILIUM GMBH, Wessling (DE)

(72) Inventors: Jan KROLLMANN, Wessling (DE); Cecil BEEHLER, Wessling (DE); Sebastain BORN, Wessling (DE); Tariq AHMAD, Wessling (DE); Emiliano IULIANO, Wessling (DE)

(21) Appl. No.: 19/136,807

(22) PCT Filed: Dec. 11, 2023
(86) PCT No.: PCT/EP2023/085141

§ 371 Date: Jun. 6, 2025

(30) Foreign Application Priority Data
Dec. 9, 2022 (EP) 22212582.5

(51) Int. Cl. F01D 5/18; B64D 27/10

(52) U.S. Cl. CPC F01D 5/18; B64D 27/10; F05D 2230/23

(57) ABSTRACT

An engine blade for an aircraft engine includes a blade body with a blade surface and a heating element for heating at least a section of the blade surface. The heating element integral with the blade body within the blade surface. A method for manufacturing the engine blade includes providing composite layers and a heating element applied on at least one of the composite layers. The composite layers are stacked and joined to form the engine blade.

### RELATED APPLICATIONS

This application is a U.S. National Stage of International Application No. PCT/EP2023/085141, filed on Dec. 11, 2023, which claims the benefit of, and priority to, EP Application No. 22212582.5 filed on Dec. 9, 2022, which is hereby incorporated by reference herein in its entirety.

### TECHNICAL FIELD

The present disclosure relates to an engine blade and an engine rotor for an aircraft. The disclosure relates also to a method of forming said engine blade and engine rotor.

### BACKGROUND

It is known that rotors are used for plane fan engines. Those rotors are usually made of a metal material to provide endurance and mechanical stability. It is also known to search for lighter materials to reduce the weight of such rotors and thereby reducing the overall weight of the respectively equipped planes. One option for such lightweight materials are so-called composite materials comprising a polymeric matrix material and reinforcing fibres. In airplanes usually only one type of such polymeric matrix and fibre combinations is used. In particular, the matrix being a polymeric matrix, has embedded reinforcing fibres, which are continuous or so-called endless fibres. The use of such continuous fibres allows a specific orientation of such fibres within the polymeric matrix during the manufacturing process. This leads to a construction, where the direction and orientation of those continuous fibres in the polymerized body of each of the rotor blades is well known. Since the mechanical stability and possibility to provide a load path for load applied to such rotor blades is strongly correlated with the orientation of the reinforcing fibres, the knowledge about such orientation is important to calculate stability and construct the rotor blades accordingly. Therefore, in commonly known efforts to provide lightweight rotor blades, such rotor blades are only possible to be produced with such continuous fibres as reinforcing fibres in a matrix material.

A problem of the present situation is that the application of endless or continuous fibres in a matrix material is relatively easy for simple shapes of rotor blades. However, for more complex structures, in particular at the root section where those blades are attached to a shaft, the endless fibres represent challenges, or the complexity of the production method is increased significantly. Therefore, according to the present knowledge, those composite material rotor blades are used in combination with regular shaft hubs for example made of steel to provide the connection to a drive shaft and to support those rotor blades in taking on the driving load.

A further disadvantage of the present solution is the fact that the rotor blades not only need to provide stability for taking on the driving load, but also to withstand further reaction loads resulting from the air load and centrifugal load while rotating as well as mechanical impacts coming from birds, stones or the like. To provide this additional or secondary mechanical stability the rotor blades are constructed with an increased size and in particular an increased weight.

A further disadvantage of the present situation is that ice can easily form on rotor blades. For instance, if ambient temperature is low but relative humidity in the surrounding air high, there is a high risk of ice forming on the rotor blades. As a consequence of ice formation, the rotor blades and rotor change their dynamic and aerodynamic characteristics, respectively. This can lead to several disadvantages, such as an undesired weight gain of the aircraft, or an imbalance of the rotor, resulting in undesired vibrations of the aircraft. Weight gain and imbalance both can cause losses of efficiency and thus, losses in flight travel range. Moreover, the present situation does not allow to remove the formed ice during a flight. Also, at present the formed ice cannot be removed in a timely and/or efficient manner.

It is an object of the disclosure to solve the above-mentioned problems at least partially.

In particular, it is an object of the disclosure to provide an easy and cost-efficient way to reduce the weight and still keep a high mechanical stability of composite material rotors. It is a further object of the disclosure to provide a lightweight rotor with heating functionality for de-icing its blades.

At least some of the described objects are achieved by an engine blade according to claim 1, an engine rotor according to claim 8, a propulsion unit according to claim 9, a method of manufacturing an engine blade according to claim 11 and claim 12, and a method of manufacturing an engine rotor assembly according to claim 15.

Further advantages and features of the disclosure can be derived from the dependent claims, the description, and the figures. Features and details described in connection with the engine blade of the disclosure naturally also apply in connection with the engine rotor of the disclosure, with the propulsion unit of the disclosure, and with each of the methods of the disclosure, and vice versa, so that, regarding the disclosure of individual aspects of the disclosure, reference is and/or can be made always mutually.

According to the present disclosure, an engine blade for an aircraft engine is provided. The engine blade comprises a blade body, which comprises a blade surface and a heating element for heating at least a section of the blade surface. The heating element is provided integral with the blade body within the blade surface.

In other words, an engine blade for an aircraft engine is disclosed that has a blade body, which is integrally provided with a heating element for heating at least a part of a surface of the engine blade.

Therein, the engine blade may preferably be understood as an airfoil for exerting thrust on air when being rotated about a rotation axis. The aircraft engine may be an electrical engine, which rotationally drives the engine blades.

The engine blade comprises a blade body with a blade surface. Therein, the blade surface may preferably be understood as outside surface surrounding the blade body.

The blade body further comprises a heating element. Therein, the heating element may be preferably understood as a device or structure for supplying de-icing energy. For instance, the heating element may be a device or structure for giving off heat. For instance, the heating element may transport a substance comprising heat energy or may generate heat by converting supplied energy into heat energy. Alternatively, it is also conceivable that, instead of providing heat energy, the heating element converts the supplied energy in other forms of energy, such as vibrational (ultrasonic, high frequency) energy for removing ice from the blade surface.

The heating element is provided integral with the blade body within the blade surface.

Therein, an integral configuration may be preferably understood as one that consists of only one piece. For instance, the heating element may be contained within the blade body. Preferably, in the integral configuration, different components or materials of the blade body may be connected to each other through interlocking connections or joints, where for example parts are joined together by fusion, melting, and/or intermolecular or chemical bonding forces, possibly using additives, such as adhesives.

Further, the expression “within the blade surface” may preferably be understood as below or on the blade surface. Thus, the heating element may be inside the blade body and/or may be at least partially surrounded by the blade surface. Alternatively, the heating element may also form at least part of the blade surface.

Thereby, it is possible to provide an engine blade with heating functionality while maintaining structural integrity, without adding a significant amount of additional weight, and to simplify manufacturing and maintenance of a corresponding aircraft engine.

Advantageously, the heating element may preferably comprise at least one heat transfer conduit. Preferably, the heat transfer conduit may be electrically conductive. Alternatively or additionally, the heat transfer conduit may extend along a wounded extension path. Alternatively or additionally, the heat transfer conduit may extend with the blade surface. Preferably, the heat transfer conduit may function as an electric resistance heater. Alternatively or additionally, the heat transfer conduit may form a passage to transport a heat transfer medium. Alternatively or additionally, the heat transfer conduit may be thermally conductive to transfer heat energy through thermal conduction.

Thereby, a path for emitting or providing de-icing energy can be provided. In particular, electrical conductor paths may be effective in generating a sufficient amount of heat for de-icing the blade surface.

Advantageously, the heating element may preferably be provided on a section of the blade body in an additive manufacturing method. For instance, the heating element may be provided by 3D-printing. Alternatively or additionally, the heating element may be provided in a depositing method.

Thereby, the heating element can be provided directly onto the blade body. Moreover, the heating element can be provided as a microstructure. Thereby, de-icing functionality can be integrated in the engine blade without deteriorating structural integrity or weight of the engine blade. Furthermore, size and shape of the heating element can be chosen freely and manufacturing speed can be increased.

Advantageously, the blade body may preferably be made of a composite material, comprising a polymeric matrix and continuous reinforcing fibres embedded in the polymeric matrix. Advantageously, the blade body may preferably comprise a layered structure. The layered structure may preferably be a composite structure. The layered structure may comprise a base layer for transmitting a driving force. The base layer may be configured for transmitting a driving force from the aircraft engine to exert thrust on the air through the blade surface. The layered structure may further comprise a heating layer that comprises the heating element.

Thereby, advantages of composite structures regarding weight can be advantageously combined with the benefits of providing de-icing functionality in an engine blade. For instance, layers of the structure may comprise a matrix material and a reinforcing component. For instance, the layered structure may comprise resin, polymer and/or glass fibre. The layers may have a material thickness from 0.1 mm to 10 mm.

Advantageously, the heating layer may preferably be arranged between the base layer and a cover layer that covers the heating layer on an opposite side to the base layer.

Thereby, the cover layer can be used to provide not only a protective cover for the heating element but also for forming a material bond between the base layer and the heating layer. Consequently, the heating element can be protected from damages during a flight.

Advantageously, the heating layer may comprise a carrier layer. For instance, the carrier layer may be a foil or a film. The heating layer further comprises the heating element, which may be integrally provided with or on the carrier layer. For instance, the heating element may be printed or deposited on the carrier layer. Advantageously, the heating layer may be integrally bound via the carrier layer to the base layer by material bonding.

Thereby, the reliability and design freedom of the heating element can be increased as the heating element can be manufactured and tested independently before being integrated in the blade body.

Advantageously, the heating layer may preferably form an integral part of the base layer. For instance, the base layer may comprise at least two base support layers. The heating layer may be arranged between the base support layers, or the heating layer may be arranged on one of the base support layers. It is also conceivable that the above-described carrier layer may be one of the base support layers.

Thereby, the heating layer contributes to the mechanical strength of the engine blade. Accordingly, the engine blade can be provided with de-icing functionality without reducing the robustness and strength of the engine blade.

Advantageously, the heating element may preferably be arranged on a radially outwards portion of the engine blade. Preferably, the heating element may be arranged between a tip section and a root section of the blade body. Moreover, the engine blade may comprise more than one heating element. For instance, two heating elements may extend on opposite lateral sides of the blade body. Alternatively or additionally, the one or more heating elements may extend or be distributed to cover the entire blade surface for heating.

Thereby, de-icing functionality can be provided at various sections of the engine blade that are typically most affected by ice formation during a flight.

Advantageously, the heating element may comprise connection sections for supplying a heat generating agent. Preferably, the heating elements may extend between a tip section of the blade body and a root section for attaching the engine blade to a drive shaft. Preferably, the connection sections may be provided at the root section. For instance, the connection sections may be electrical connectors.

According to the present disclosure, an engine rotor for propelling an aircraft is provided. The engine rotor comprises at least one of said engine blade. For instance, the aircraft may be an aircraft for vertical take-off and landing. The engine rotor may comprise a hub device and a plurality of the engine blades, which may be arranged to extend radially from the circumference of the hub device. Preferably, the engine blades may be set around the circumference of the hub device at a pitch to form a helical spiral.

Therein, the engine rotor (also sometimes referred to as rotor in the following) may preferably be understood as a drive device of an aircraft engine that comprises the engine blades and rotates with the engine blades for generating thrust. The hub device may be a central part of the engine rotor, to which all engine blades may be connected. Preferably, the hub device may be a ring. Preferably, the hub device may be connected to a drive shaft of the aircraft engine.

According to the present disclosure, a propulsion unit for propelling an aircraft is provided. The propulsion unit comprises said engine rotor and an engine housing with an engine duct, in which the engine rotor is arranged rotatably about a rotation axis.

With the above-described further aspects of the disclosure, the same advantages and technical benefits can be derived as described above for the engine blade.

Advantageously, the engine rotor and/or the propulsion unit may comprise an agent supply device for supplying a heat generating agent to the heating element for heating the blade surface. Preferably, the agent supply device may supply the heat generating agent to the connection sections of the heat element. Preferably, the agent supply device may transmit the heat generating agent cable-bound (e.g. through wire connections) or contactless (e.g. wirelessly).

In one example, the agent supply device may preferably comprise an inductive supply device to supply inductively electric energy as the heat generating agent to the heating element. Therein, the engine housing may comprise the inductive supply device. The inductive supply device may preferably be arranged at an upstream section of the engine duct. The inductive supply device may preferably be arranged upstream of the engine blade. Further, the inductive supply device may preferably be arranged radially outwards from the engine blade. Preferably, the heating element may be correspondingly provided as an electric resonant circuit to receive inductively electric energy from the inductive supply device.

Thereby, energy required for de-icing can be transmitted wirelessly to the engine blade. Accordingly, cables and electrical connections can be avoided so that the complexity of the structure of the propulsion unit can be reduced.

Alternatively or additionally, the agent supply device may preferably comprise a slip ring for supplying electric energy as the heat generating agent to the heating element. Therein, the engine rotor may comprise the slip ring. Preferably, the slip ring may be integral with the engine rotor. Moreover, the slip ring may be arranged relatively movable to the engine housing. Preferably, the slip ring may be arranged coaxially with the rotation axis and may preferably be arranged radially inwards with respect to the root section.

Therein, a slip ring may preferably be understood as a transmission device for electrical power from a stationary structure (e.g. engine housing) to a rotating structure (e.g. engine rotor).

Thereby, the engine rotor can be integrally provided with means for supplying electric energy to the heating elements despite the engine blades rotating during the flight.

According to the present disclosure, an aircraft for vertical take-off and landing is provided. The aircraft comprises at least one of said propulsion unit.

According to the present disclosure, it is provided a method of manufacturing an engine blade having a blade body with an integrated heating element for heating at least a section of a blade surface. Therein, the heating element may be printed or deposited on the blade body. Further, the heating element may be applied with a cover layer, to form at least the heated section of the blade surface. For example, the cover layer may be an adhesive or resin.

For instance, the heating element may be provided in a process suitable for generating three dimensional structures, such as etching, vapour deposition or printing.

Thereby, the heating element can be provided directly on the blade body so that the structural integrity of the blade body remains unchanged. The cover layer can provide a protective cover for the heating element. Not only allows this to provide the engine blade with a minimal number of manufacturing steps, but it also facilitates easy integration and testing of the de-icing functionality on the engine blade. Furthermore, the heating element can be provided in close proximity to the blade surface and thus, de-icing efficiency can be improved since the emitted energy has to travel through fewer layers.

According to the present disclosure, it is provided a method of manufacturing an engine blade having a blade body with an integrated heating element for heating at least a section of a blade surface. Composite layers for the engine blade are provided. The heating element is provided and applied on at least one of the composite layers. The composite layers for the engine blade are stacked. The composite layers are joined to form the engine blade.

Advantageously, providing and applying the heating element may be preferably done before stacking. Preferably, said composite layer may be an uncured layer. Advantageously, the provision and application of the heating element may comprise, for instance, printing the heating element on at least a section of said composite layer. Alternatively or additionally, it may comprise printing at least one electrically conducting heat transfer conduit directly onto said composite layer. Alternatively or additionally, it may comprise arranging and curing the heating element (preferably with the carrier layer) on at least a section of said composite layer. Alternatively or additionally, it may comprise arranging and bonding the heating element (preferably with the carrier layer) on at least a section of said composite layer.

With any of the above configurations, the heating element can be provided on a structural carrier element, such as a glass fibre reinforced slat, which can be subsequently integrated in the blade body to form a respective part thereof, and consequently, can contribute to transmitting forces after all layers are joined together. Consequently, mechanical strength of the engine blade can be improved. As an added benefit, manufacturing speed can be increased since the configuration of the method facilitates to provide the heating element in a step that is independent from providing other composite layers.

Advantageously, joining the composite layers may preferably comprise molding, injection molding, composite pressing, laminating, curing, and/or bonding.

For instance, precut reinforcement layers may be iteratively placed into a mold and covered with a resin. Curing may be started once the desired structure is achieved.

According to the present disclosure, it is provided a method of manufacturing an integral engine rotor assembly. In the method, a plurality of engine blades comprising a blade body with a blade surface are provided. Therein, at least one of the engine blades is manufactured in one of the above methods of manufacturing an engine blade. Further, a hub device for receiving and supporting root sections of the engine blades is provided. The engine blades and the hub device are arranged to form an engine rotor assembly. The engine blades and the hub device are joined to form the integral engine rotor assembly.

Therein, an engine rotor assembly may be preferably understood as a structure comprising a combination of different parts, such as at least the engine rotor.

With the above configuration, all parts typically involved in an engine rotor assembly can be provided integral with each other. Thereby, at the end of the process one unitary structure may be received as the engine rotor assembly.

Advantageously, joining the engine blades and the hub device may preferably comprise an injection molding, composite pressing, and/or bonding.

Advantageously, providing the hub device may preferably comprises forming the hub device by pressing or injection molding. For instance, the hub device may be from a composite material, comprising a polymeric matrix and chopped reinforcing fibres embedded in the polymeric matrix. Preferably, the step of forming the hub device may comprise providing and arranging at the hub device said agent supply device, in order to provide the agent supply device integral with the hub device.

Thereby, other functional components, which may be required for supplying the heating element with energy for de-icing, can be simply embedded with the engine rotor assembly so that an integral engine rotor can be received including the heating elements in the engine blades and the agent supply device in a single manufacturing process. An advantage of using chopped fibres is that they lead to an isotropic material, which allows to carry mechanical strains or loads equally well irrespective of their direction.

Alternatively or additionally, the disclosure includes further configurations of the engine rotor, to which in the following is simply referred to as “rotor”. Thus, features described in relation to the following rotor, engine or method are equally applicable to the above described aspects of the disclosure. For example, features of the below described “rotor blade” are equally applicable to the above described “engine blade”.

According to the present disclosure, a rotor is constructed to be used in a ducted fan engine. Such a rotor comprises a plurality of rotor blades, each having a blade body with a root section to be connected to a drive shaft to receive a primary driving load to provide a primary load path. Additionally, such a blade body comprises a tip section which is positioned at the opposite end of the blade body. The plurality of rotor blades is arranged circumferentially to form the mentioned rotor. Additionally, the rotor comprises a rotationally symmetrical load bearing element which is in force transferring contact with the plurality of blade bodies in a load bearing section. Such a load bearing section is located between the root section and the tip section of all of the blade bodies and therefore the load bearing element can provide a secondary load path for at least a part of the reaction load of the blade bodies. Moreover, the blade bodies of the rotor blades are made of a composite material comprising a polymeric matrix and continuous reinforcing fibres embedded in that polymeric matrix. The load bearing element is also made of a composite material comprising a polymeric matrix but it further comprises chopped reinforcing fibres embedded in such polymeric matrix.

According to the present disclosure, the rotor is made of composite material and thereby offers the possibility of a lightweight construction and the respective reduction of overall weight when used for an airplane. To provide stability of the rotor blade as a primary functionality element itself, the composite material for those blade bodies comprises the polymeric matrix with the known continuous reinforcing fibres. That means that the blade bodies can be constructed in the commonly known way thereby providing the necessary and well-known mechanical stability to take on the driving load from a rotating shaft.

In contrast to the commonly known technology, the mechanical stability for secondary loads, namely reaction loads applied on the rotor blades, is now shifted from the blade bodies at least partly to a secondary element which is formed as a load bearing element according to the present disclosure. Such a load bearing element therefore is separate from the connection to the shaft and thereby provides a separate so called secondary load path to take on at least partly those secondary loads like reaction forces coming from the blade bodies. Due to the fact that such load bearing element is in force transferring contact with all of the blade bodies it can take on the reaction load from all of those blade bodies. Moreover, the transfer contact to transfer the forces is located between the tip section and the root section such that a leverage effect is created between the reaction force at the tip of the rotor blade and the respective transfer into the secondary load path in the intermediate load bearing section of the blade body. The same is also in place for any impacts that result in respective reaction forces at the central hub where the shaft is to be connected to the rotor blades.

According to the discussion above, the load bearing section therefore is located in an intermediate part in between and spaced apart from the tip section of the blade bodies as well as from the root section of the blade bodies. For example, the load bearing element can form some kind of a symmetrical ring surrounding the driving shaft and thereby connecting in this circumferential extension all of the blade bodies and thereby the rotor blades. As discussed later the load bearing element can provide further functionality in particular enhance the aerodynamical functionality of the rotor itself.

According to the present disclosure, one aim is to combine a high mechanical stability with the maximum reduction of weight. To achieve this goal the present disclosure provides the load bearing element with a composite material such as it is a lightweight material by itself. Due to the fact that the load bearing element now separates the secondary loads from the main driving loads it is possible to construct the composite material of the load bearing element free and in particular not with the commonly known continuous or endless fibres but to use much so called chopped or short fibres.

Since the chopped or short fibres are randomly orientated in the matrix material of the composite material of the load bearing element, the knowledge about the mechanical stability and the orientation of the mechanical resistance is less predictable in comparison to the use of endless or continuous fibres. However, the construction of more complex structures, in particular, a complex circumferential and rotationally symmetrical structure like the inventive load bearing element, is much easier to be produced than with the use of continuous fibres. In an airplane in terms of stability prediction the most critical load is the driving load to be applied from the rotor shaft centrally via a hub to the plurality of the rotor blades. That main load or driving load can still be transferred by use of the reinforcing stability provided by the continuous fibres in the matrix material of the blade bodies. The additional mechanical stability which is necessary and is provided by the load bearing element is now provided by a cheaper and less complex material using the chopped fibres. Thereby the same lightweight advantages can be applied to the load bearing element, but without the limiting complexity for producing the complex structure full of that load bearing element. In other words, the present disclosure allows a combination of the lightweight advantage of composite material with different complexities of the different elements of the structure of the rotor. This combination is only possible due to the separation of the primary load handling for the driving load and the secondary load handling for the reaction load isolated at least partly in the load bearing element.

It can be an advantage according to the present disclosure when the load bearing element and the rotor blades are formed as monolithic construction. While the general combination and force transferring contact can be also provided by a mechanical contact, by a form fit contact or the like, a material bridge of a monolithic construction between the load bearing element and the load bearing section of the blade bodies is of advantage. This can either be achieved by use of an adhesive vulcanising the materials of both contacting elements, by a welding step or a thermoplastic melting step. The monolithic combination is in particular related to the use of thermoplastics as polymeric matrix material for the blade bodies as well as for the load bearing element. By melting the matrix materials together, a monolithic construction is achieved thereby allowing a bonding between those two elements with an increased mechanical stability and also providing an easier production method that is described in more detail later.

Additionally, it is possible that, according to the present disclosure, the polymeric matrix of the blade bodies and the polymeric matrix of the load bearing elements are selected from the same group of material, in particular thermoplastics. As already mentioned above, it is preferred to provide a monolithic construction of the blade bodies and the load bearing element. One preferred way to achieve such a monolithic construction is the use of thermoplastics which can be welded or melted together. In particular, by using thermoplastics with a similar or almost an identical melting point, a welding step and thereby a melting of both matrix materials of both elements is possible and further a material connection between the load bearing element and the blade body is achievable. Those thermoplastics can comprise high performance thermoplastics like PEEK and PEKK. Alternatively, to similar or identical melting points, it can be an advantage, if the melting point of the matrix material of the load bearing element is significantly higher than the melting point of the matrix material of the blade bodies. In particular, when a method for production is used that is described below, the second molding step comprises the injection of melted high temperature matrix material from the load bearing element into a mold wherein the already molded blade bodies are already placed. By injecting the matrix material of the load bearing element with a high temperature this material also provides a heat transfer to the already hardened matrix material of the blade bodies in the load bearing section. In other words, the injected high temperature matrix material is now possible to transfer such heat at least partly to the matrix material in the load bearing section, the temperature succeeds the lower melting point of the matrix material of the load bearing section and thereby the material bridge for the monolithic construction can be achieved in an easy and sufficient manner. In particular, no separate heat source is needed to remelt the matrix material in the load bearing section.

Additionally, it can be an advantage that the load bearing element of an inventive rotor comprises a primary load bearing part in force transferring contact with the load bearing section on the blade bodies and a secondary load bearing part in force transferring connection with the root section of the blade bodies. While improved mechanical stability is already achieved by the one single primary load bearing part, a separation into two or even more load bearing parts is also possible. In particular, it can be an advantage if the central hub at the root section of the blade bodies is also using the inventive combination of monolithic construction between the load bearing element and the blade bodies. All of the load bearing parts comprise the matrix material and the reinforcing chopped fibres. Thereby also the driving load can be at least partly transferred via that secondary load bearing part into the root section of the blade bodies.

It is also an advantage if, according the present disclosure, the load bearing element at least partly extends in axial direction beyond the load bearing section of the blade bodies. This allows in particular to encapsule the blade bodies in the load bearing section. Since reaction loads in particular can be separated in centrifugal loads, impact load as well as air loads on the blade bodies at least the air loads and the impact loads would result in reaction loads also in the axial direction. The further extension of the load bearing element beyond the shape of the blade body in that axial direction allows an even better force transfer to take on those reaction loads from the blade body and guide it along the provided secondary load path. The extension is in particular on both sides of the blade bodies namely in front of the blade bodies as well as after the blade bodies following the air stream through the rotor.

Additionally, it can be an advantage if the outer surface of the load bearing element comprises an aerodynamical functional shape. An aerodynamical functional shape has to be understood as a shape with an aerodynamical function. In other words, the outer side of the load bearing element is constructed to provide reduced aerodynamical resistance and/or to provide a guiding functionality or even a covering functionality for the airflow through the rotor. Since the driving shaft of the engine in the duct is usually to be covered from the airflow the load bearing element can provide that covering functionality as a secondary functionality. For example, the outer surface of the load bearing element can provide a cone shape or a curved shape to reduce the air flow resistance and provide the mentioned guiding and/or covering functionality. The functionality can thereby be considered as a passive aerodynamical functionality. Of course, beside the discussed relatively easy aerodynamical functionalities, also more complex guiding functionalities, like the provision of additional rotor elements or guiding fins, are generally possible to be implemented on the outer surface of the load bearing element.

An advantage can further be achieved if the load bearing element of the rotor extends axially beyond the blade bodies, following a rotationally symmetrical curved shape creating a pointed nose. Since the pointed nose could also be provided by a separate element the incorporation into the load bearing element reduces the complexity even further. Due to the fact that for the load bearing element the chopped reinforcement fibres can be used the increased complexity by integrating the cone shaped pointed nose is not of relevance in terms of the complexity of the production method. In other words, the spinner in front of the rotor can be integrated in a monolithic way into the construction of the load bearing element and thereby the overall complexity for manufacturing and mounting can be reduced significantly. Beside reduction of complexity the use of the same lightweight material for the spinner as being part of the load bearing element will optimise the inventive advantage of lightweight construction for the overall rotor.

A further advantage can be achieved if the load bearing element provides a hollow cavity. The hollow cavity is preferably inside of the load bearing element and facing the root section of the blade bodies. Providing the hollow cavity means can be understood as no material or less material is located in that hollow cavity and thereby the overall weight of the rotor can be reduced even more. Additionally, that hollow cavity can be used to shield other mechanical elements, in particular the driving shaft of the engine, from air flow entering that hollow cavity and interacting with those mechanical elements. The construction of a hollow cavity is in particular combined with an outer surface of the load bearing element providing the aerodynamical functional shape as discussed above.

A further advantage can be achieved if the blade bodies extend between the root section and the load bearing section in a linear or substantially linear manner. That extension allows to reduce the complexity of the shape of the blades to that section where the interaction with the airflow exists. Since in preferred embodiments airflow is shielded by the outer surface of the load bearing element to enter the hollow cavity inside or close to the root section no airflow interaction results in that part of the blade bodies between the load bearing section and the root section. Thereby in that part of the blade body the complexity of the structure can be reduced such that the blade body follows on more or less straight or linear extension. Furthermore, the structure of the blade bodies between the load bearing section and the root bearing section can be even further reduced as to mechanical stability since reaction loads resulting from airflow, centrifugal load applied on the tip section of the blade bodies is at least partly transferred to the secondary load part of the load bearing element, such that less mechanical load has to be guided through the part of the blade bodies between the load bearing section and the root section. In other words, the blade body can be reduced as to its weight even further as to this discussed intermediate section of the bodies.

It can be of advantage that, according to the present disclosure, the load bearing element surrounds the load bearing section completely or at least substantially completely. In other words, the surrounding form can allow an extension as discussed above in the axial direction beyond the shape of the blade bodies. It allows an easier and better transfer of reaction loads into the secondary load path provided by the load bearing section and additionally covers the aerodynamic function as also discussed above. The substantially completely surrounding and covering of the load bearing section further allows a form fit between the load bearing element and the load bearing section which is discussed below.

It can be an advantage that, according to the present disclosure, the load bearing section and the blade bodies comprise a contact surface extending at least partly along an axial direction of the rotor. This allows a form fit as discussed above and thereby in particular increases and optimises the transfer of centrifugal loads from the tip section of the blade bodies as reaction load into the secondary load path provided by the load bearing section. This can be used as form fit functionality only or can be combined with a monolithic construction using a material junction between the matrix material of the load bearing section and the load bearing element.

An additional advantage can be achieved when the load bearing element comprises rounded edges at least at contact sections to the blade bodies. In particular, when a method is used including injection molding steps rounded edges can provide additional advantages for that injection molding process. Furthermore, after the production at the rounded edges reduce the stress created during usage of the rotor and thereby can be avoided or at least reduced. A rounded edge according to the present disclosure comprises an edge radius in particular between one millimetre and ten millimetres.

It is also an advantage according to the present disclosure if the rotor comprises at least one of the following geometric dimensions:
Radial extension of the load bearing section compared to the overall radial extension of the blade body between 20% and 50%,
Radial distance between the load bearing section and the root section of the blade bodies between 20 and 50 millimetre,
Radial distance between the load bearing section and the tip section of the blade bodies between 100 and 150 millimetre,
Radial extension of the blade body between 20 and 150 millimetre,
Number of rotor blades between 3 and 35.

It can further be an advantage that, according to the present disclosure, all rotor blades are identical or substantially identical. In particular, this reduces complexity and the number of different parts and thereby reduces the costs to produce such a rotor. The identity is in particular relevant to the material as well as the form of the rotor blades.

It is a further object of the present disclosure to provide a method of forming a rotor with the features according to the present inventive rotor. Such a method comprises the following steps:
Molding a composite material comprising a polymeric matrix and continuous reinforcing fibres into a cavity forming a rotor blade, having a blade body with a root section to be connected to a drive shaft to receive a primary driving load and a tip section at the opposite end of the blade body,
Arranging a plurality of such rotor blades into a jig,
Molding a composite material comprising a polymeric matrix and chopped reinforcing fibres into a cavity forming a load bearing element, wherein such a load bearing element is formed in force transferring contact with a plurality of blade bodies and in a load bearing section located between the root section and the tip section. This provides a secondary load path for at least a part of reaction loads of the blade bodies.

By forming an inventive rotor, the inventive method comes along with the same advantages as discusses in detail with respect to inventive rotor. As can be seen in the inventive method, the use of the different fibres for the different parts of the rotor allows cheap and simple injection molding steps to produce the separate elements of the rotor, in particular the rotor blades as well as the load bearing elements. By use of the different fibre types for the reinforcing fibres between the different elements of the rotor, the different needs for the load situations can be addressed in a way that still keeps complexity and weight of the rotor low.

It can be an advantage if for both molding steps an injection molding process is used. In particular, this can comprise the use of polymeric matrix materials being selected from a thermoplastic material type. In particular, this can be described as so-called overmolding while the injected fluid matrix material of the load bearing element remelts the matrix material of the rotor blades in their load bearing section to create a material junction between those two parts.

It can be further of advantage according to the present disclosure during the second molding step if the molding temperature of the polymeric matrix of the load bearing element is set at or above the melting temperature of the polymeric matrix material of the blade bodies. In other words, no separate heating of the matrix material of the blade bodies is necessary since there is enough heat transferred in the melted matrix material of the load bearing element such that while arriving in a melted form at the load bearing section this transferred heat can be used to remelt the polymeric matrix material of the blade bodies in those load bearing sections.

### BRIEF DESCRIPTION OF THE DRAWINGS

The present disclosure is further described in relation to the accompanying drawings. Those drawings show in a schematic way:

FIG. 1 shows an exemplary embodiment of an inventive rotor, according to certain aspects of the present disclosure;

FIG. 2 shows an exemplary embodiment of a part of an inventive rotor, according to certain aspects of the present disclosure;

FIG. 3 shows a cross section of an exemplary embodiment of an inventive rotor, according to certain aspects of the present disclosure;

FIG. 4 shows a cross section of a further exemplary embodiment of an inventive rotor, according to certain aspects of the present disclosure;

FIG. 5 shows a further cross section of a part of an exemplary embodiment of an inventive rotor, according to certain aspects of the present disclosure;

FIG. 6 shows a further cross section of a part of a further exemplary embodiment of an inventive rotor, according to certain aspects of the present disclosure;

FIG. 7 shows an exemplary first step of an inventive method, according to certain aspects of the present disclosure;

FIG. 8 shows a further exemplary step of an inventive method, according to certain aspects of the present disclosure;

FIG. 9 shows an exemplary aerial vehicle with inventive rotors, according to certain aspects of the present disclosure;

FIG. 10 shows a further exemplary embodiment of an inventive rotor, according to certain aspects of the present disclosure;

FIG. 11 shows the exemplary inventive rotor of FIG. 10 in a different view, according to certain aspects of the present disclosure;

FIG. 12 shows the exemplary inventive rotor of FIG. 10 in another different view, according to certain aspects of the present disclosure;

FIG. 13 shows the exemplary inventive rotor of FIG. 10 in a cross-sectional view, according to certain aspects of the present disclosure;

FIG. 14 shows the exemplary inventive rotor of FIG. 10 in a further different view, according to certain aspects of the present disclosure;

FIG. 15 shows the exemplary inventive rotor of FIG. 10 in yet another different view, according to certain aspects of the present disclosure;

FIG. 16 shows an exemplary embodiment of a rotor blade, according to certain aspects of the present disclosure;

FIG. 17 shows the exemplary rotor blade of FIG. 16 in a different view, according to certain aspects of the present disclosure;

FIG. 18 shows an exemplary embodiment of an inventive engine blade, according to certain aspects of the present disclosure;

FIG. 19A shows a cross-sectional view taken generally along line A-A in FIG. 18, showing an exemplary embodiment of the inventive engine blade, according to certain aspects of the present disclosure;

FIG. 19B shows a cross-sectional view taken generally along line A-A in FIG. 18, showing another exemplary embodiment of the inventive engine blade, according to certain aspects of the present disclosure;

FIG. 19C shows a cross-sectional view taken generally along line A-A in FIG. 18, showing yet another exemplary embodiment of the inventive engine blade, according to certain aspects of the present disclosure;

FIG. 20 shows a cross-section of an exemplary embodiment of an inventive engine rotor, inventive engine rotor assembly, and inventive propulsion unit, according to certain aspects of the present disclosure;

FIG. 21 shows a cross-section of a further embodiment of an inventive engine rotor, inventive engine rotor assembly, and inventive propulsion unit, according to certain aspects of the present disclosure;

FIG. 22A shows an exemplary method step of an inventive method of manufacturing the inventive engine blade, according to certain aspects of the present disclosure;

FIG. 22B shows additional exemplary method steps of an inventive method of manufacturing the inventive engine blade, according to certain aspects of the present disclosure;

FIG. 22C shows a further exemplary method step of an inventive method of manufacturing the inventive engine blade, according to certain aspects of the present disclosure;

FIG. 23A shows an exemplary method step of an inventive method of manufacturing an inventive engine rotor assembly, according to certain aspects of the present disclosure;

FIG. 23B shows an additional exemplary method step of an inventive method of manufacturing an inventive engine rotor assembly, according to certain aspects of the present disclosure; and

FIG. 23C shows a further exemplary method step of an inventive method of manufacturing an inventive engine rotor assembly, according to certain aspects of the present disclosure.

### DETAILED DESCRIPTION

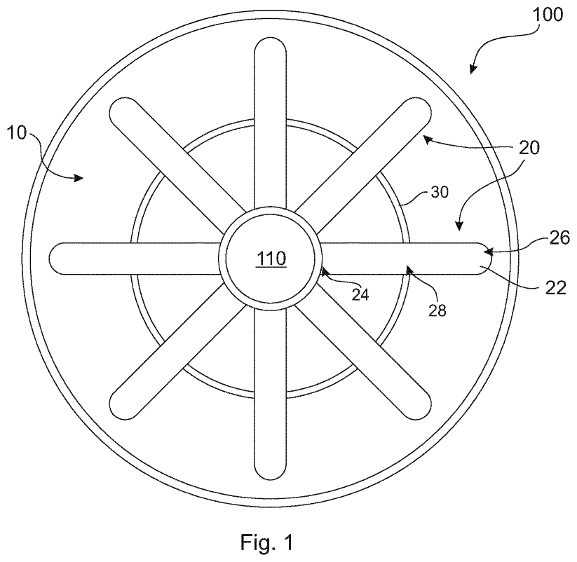

FIG. 1 shows along the axial direction AD one example of an inventive rotor 10. This comprises a plurality of rotor blades 20 forming the rotor 10 and thereby creating fan engine 100 in a ducted construction. To provide driving load to the rotor 10 a drive shaft 110 is provided, that is in a driving force contact with a hub, in this case the root sections 24 of all of the rotor blades 20. While operation the drive shaft 110 rotates and thereby transfers the driving load to rotate all of the rotor blades 20.

During operation further load up is applied to the blade bodies 22, for example impact loads, centrifugal loads CL and/or air loads AL as discussed later on. Those secondary loads are now at least partly taken on by the rotationally symmetrical load bearing element 30, which is connected to all of the blade bodies 22 in the load bearing sections 28. In other words, at least a part of the secondary loads is now taken on by the load bearing elements 30 and does not need to be transferred all the way through the root sections 24 of the blade bodies 22.

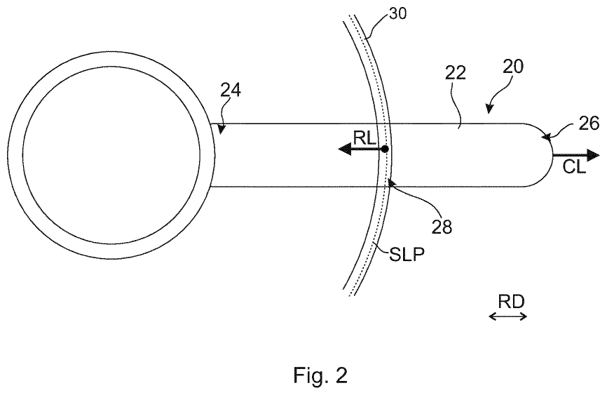

FIG. 2 shows a detail of the solution of FIG. 1 focusing on one of the blade bodies 22. During operation a secondary load in form of a centrifugal load CL is applied at the tip section 26 of the blade body 22 along the radial direction RD. To keep the mechanics stable, a reaction load RL has to be taken on against this centrifugal load CL, which can now be taken on by the load bearing element 30 and be transferred via the load bearing section 28 in the circumferential secondary load path SLP. In other words that reaction load RL is separated from the driving load DL (not depicted in FIG. 2) and is now taken away from the mechanical stability of the root section 24 of the blade body 22 of the rotor blade 20.

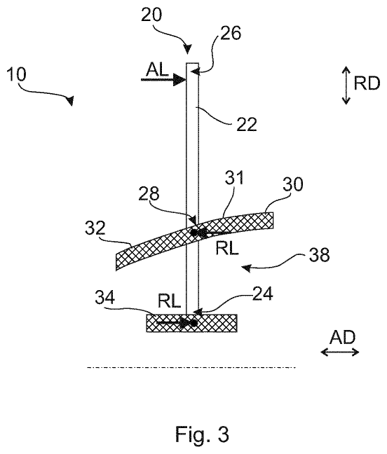

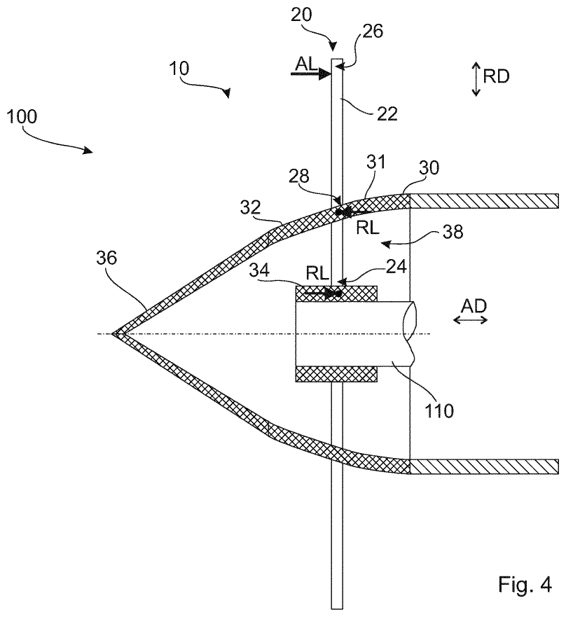

In FIG. 3 a side cross section is depicted. While rotating round the rotational axis extending along the axial direction AD, each of the rotor blades 20 are now subject to an air load AL resulting from operating an airplane. That air load AL now creates also a reaction load RL with a lever extending between the tip section 26 and the load bearing section 28 as well as a further lever extending to the root section 24. In this embodiment the load bearing element 30 comprises a primary load bearing part 32 and a secondary load bearing part 34 which can be connected or, as depicted in FIG. 3, separated from each other. Thereby a hollow cavity 38 is created in between the primary load bearing part 32 and the secondary load bearing part 34 reducing the need of material and thus the overall weight of such a rotor 10. Additionally, as can be seen in FIG. 3, the outer surface 31 of the load bearing element 30 has an aerodynamical functional shape, guiding the air flow and avoiding air entering the hollow cavity 38. This can in particular be seen in correlation with a spinner that can be separate or, as shown in FIG. 4, integrated in the load bearing element 30.

FIG. 4 shows the combination of the embodiment of FIG. 3 integrated in a fan engine 100 according to FIG. 1. Now a spinner or a pointed nose 36 is provided as being a monolithic integral part of the load bearing element 30, here the primary load bearing part 32. Also, it can be seen that the drive shaft 110 is in connection with the root sections 24 of all blade bodies 22 or the secondary load bearing part 34 to apply the driving load for rotating the rotor 10.

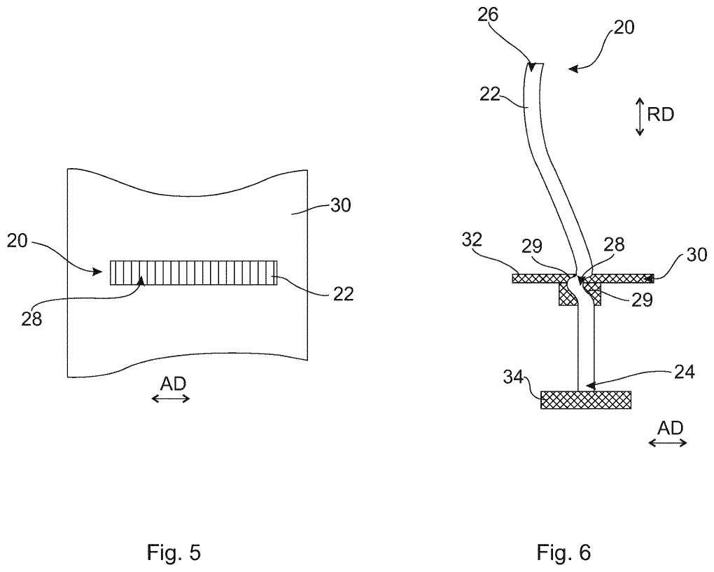

In FIG. 5, it can be seen that along the axial direction AD depicted the load bearing section extends beyond the edges of the load bearing sections 28 at both ends in axial direction AD. In particular, when taking on reaction loads RL resulting from air loads AL, as it can be seen in FIGS. 3 and 4, that additional material can take on those reaction loads RL in a better and more stable way.

FIG. 6 shows a further increased complexity in geometrical shape of the load bearing section 28. Since this load bearing section 28 now comprises contact surfaces 29 extending at least partly along the axial direction AD additionally to a potential material junction between the thermoplastic matrix materials a form fit along the radial direction RD can be achieved. This allows the integration and the transfer of centrifugal load CL in an even better way into the reaction load RL of the secondary load path SLP of the load bearing element 30.

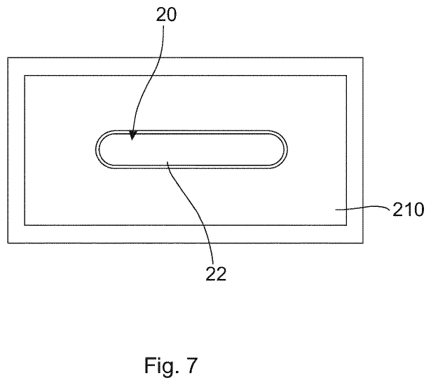

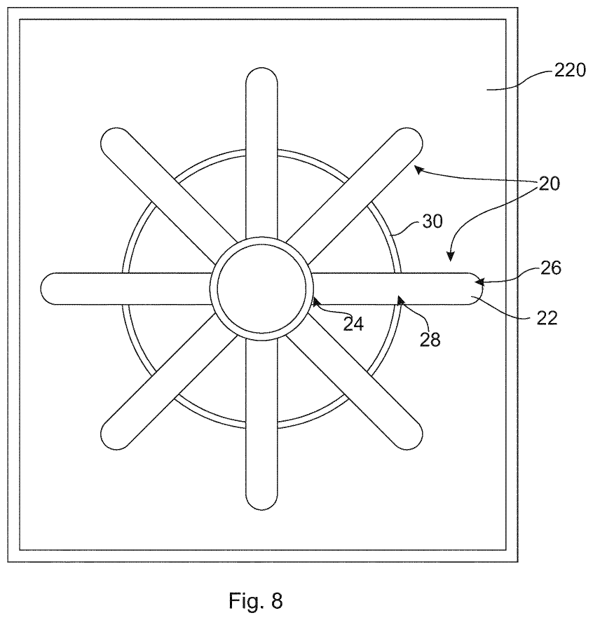

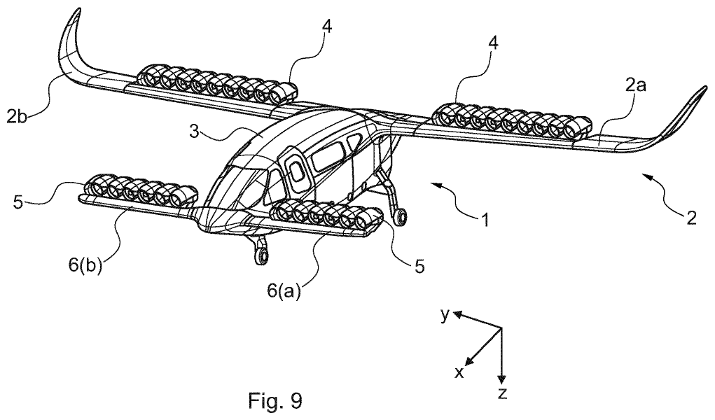

FIGS. 7 and 8 show a method according to present disclosure, wherein in FIG. 7 one single rotor blade 20 is formed in a respective blade mold 210. This is done several times to produce a plurality of identical or substantially identically rotor blades 20 which then can be placed in a jig like a rotor mold 220 according to FIG. 8. Now via injection molding the melted material for creating the load bearing element 30 is injected and remelts the load bearing sections 28 of all the contacted blade bodies 22. At the end of this injection molding process not only a form fit functionality but also a material junction can be achieved between the load bearing sections 28 of the blade bodies 22 and the material of the load bearing element 30. FIG. 9 shows an aerial vehicle which is designated by reference numeral 1. The aerial vehicle 1 comprises an airfoil 2. In particular, the aerial vehicle 1 comprises a left airfoil 2a and a right airfoil 2b extending on both sides of the longitudinal axis of a fuselage 3, respectively along a transversal axis of the aerial vehicle. The transversal axis extends along a wing span of the airfoils 2a and 2b.

On both of the left and right airfoils 2a and 2b, a plurality of propulsion units 4 are attached. The propulsion units 4 are attached to a rear portion, in particular a rear end portion, of the airfoil 2. The plurality of propulsion units 4 are aligned along the transversal axis of the aerial vehicle 1. The propulsion units 4 are attached to be pivotable about the transversal axis. In particular, the propulsion units 4 are pivotable between a substantially horizontal angular position (cruise state) and a substantially vertical angular position (hover state). On the airfoils 2a and 2b, nine propulsion units 4 are provided, respectively. An actuator is provided for each propulsion unit 4 to set the angular position of the propulsion unit 4 with respect to the airfoil 2. In addition, the aerial vehicle 1 comprises a canard 6. In particular, a left canard 6a and a right canard 6b are provided to both sides of the longitudinal axis in front of the airfoils 2a and 2b. Front propulsion units 5 are attached to a rear portion, in particular to a rear end portion of the canards 6. The front propulsion units 5 are also attached to the canard 6 to be pivotable around an axis parallel to the transversal axis. On the canards 6a and 6b, six propulsion units 4 are provided, respectively. It is preferable that both of propulsion units 4 and front propulsion units 5 are of a ducted fan type. Also, they may be electrically driven by a rotary electric machine such as an electric motor.

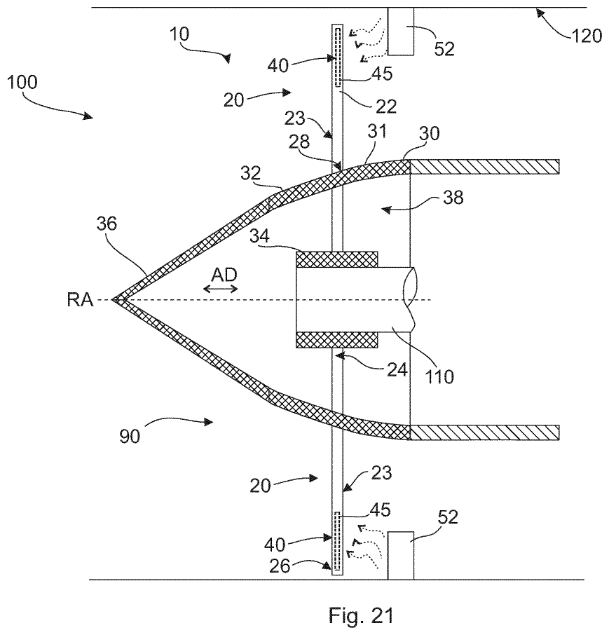

The propulsion units 4 and the front propulsion units 5 comprise a flight control surface, in this case a flap, in order to generate additional lift. In other words, the outer case of the propulsion units 4 comprises a lift generating body. Each of the propulsion units 4 and the front propulsion units 5 can generate a thrust force by rotation of the fan driven by the electric motor. It is to be noted that each propulsion unit 4 and each front propulsion unit 5 may have a plurality of ducted fans. In one aspect of the disclosure, at least one of the propulsion units 4, 5 comprises the rotor 10 (also referred to in the following as engine rotor 10) with one or more of the rotor blades 20 (also referred to in the following as engine blades 20). Preferably, the rotor blades 20 may form said fan that is driven by the electric motor. Therein, at least one the propulsion units 4,5 is provided with an engine housing 120 with an engine duct, in which the rotor 10 is arranged rotatably about a rotation axis RA (cf. following FIG. 21). Thereby, the aforementioned configuration of ducted fans can be derived, for example.

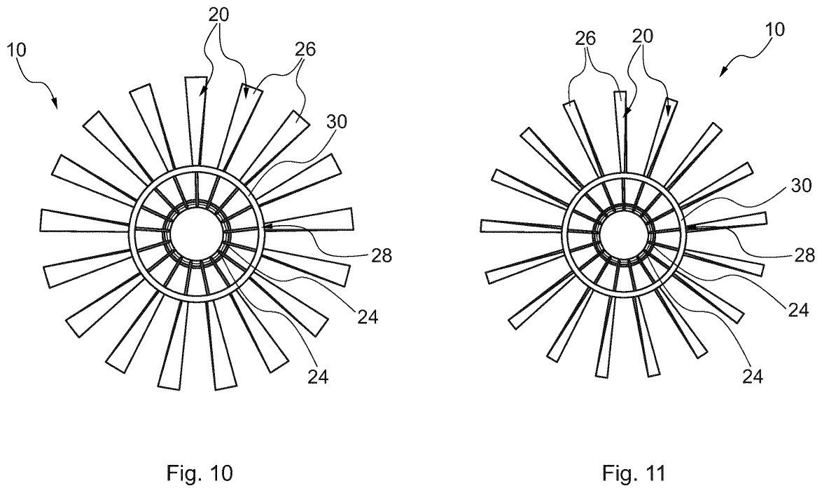

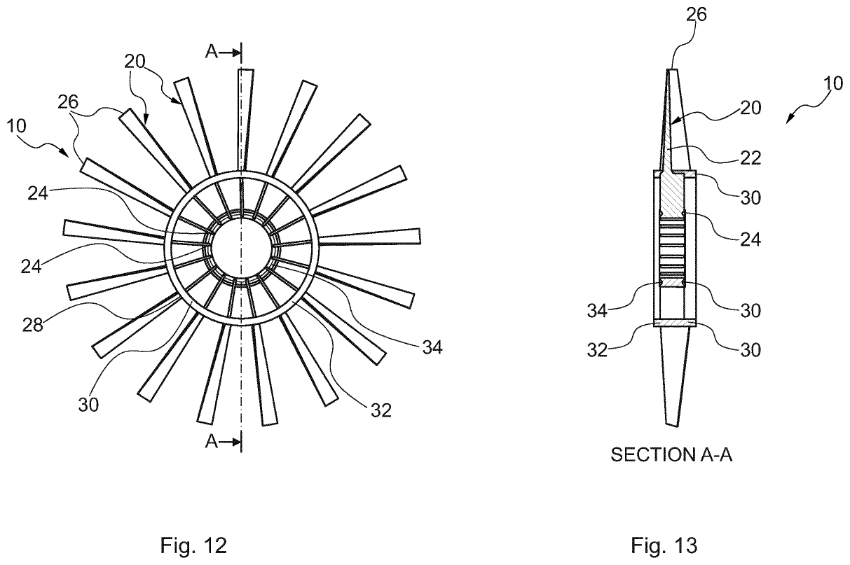

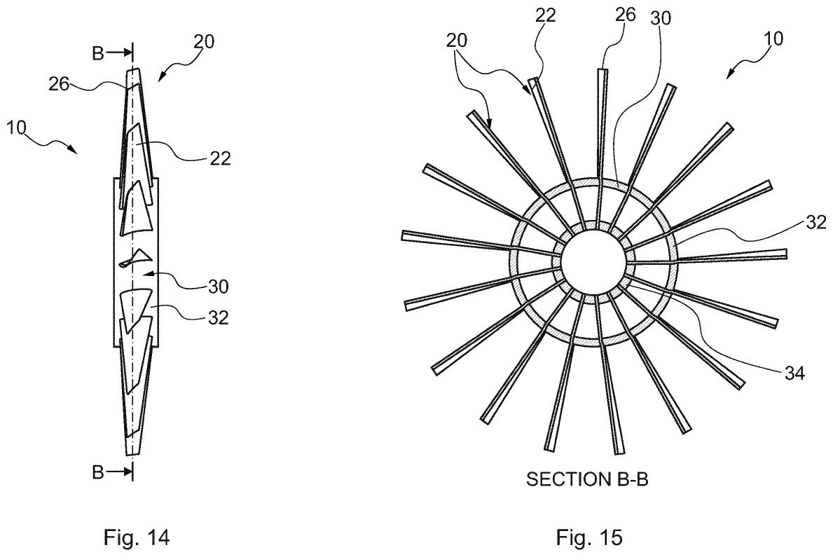

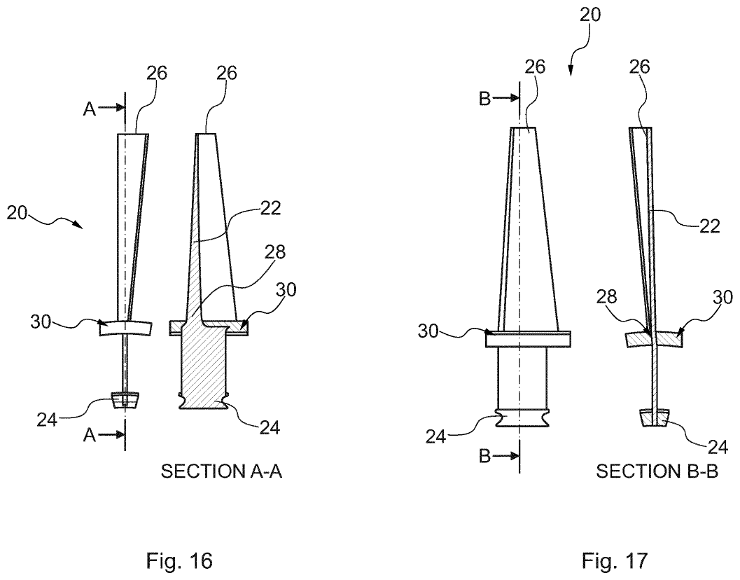

The FIGS. 10 to 17 show a further embodiment of an inventive rotor 10 in different views. In this embodiment, the load bearing element 30 comprises a first load bearing part 32 and a second load bearing part 34. Additionally, in FIGS. 16 and 17 a single blade 20 is depicted. Both figures show the same blade body in different views and with different square sections. As it can be seen in those figures, load bearing element 30 extends in axial direction beyond the edges of the load bearing section 28 of the blade bodies 22. Further, a dove tail connection is part of this embodiment to provide a form fit to a shaft and to transfer the primary load to the rotor body.

To summarize some of the important aspects of the above-described rotor 10, the following exemplary embodiments are provided:
Exemplary Embodiment 1. a Rotor 10 for a Ducted Fan Engine 100, Comprising:
a plurality of rotor blades 20, each having a blade body 22 with a root section 24 to be connected to a drive shaft 110 to receive a primary driving load to provide a primary load path and a tip section 26 at the opposite end of the blade body 22, being arranged circumferentially to form the rotor 10,
a rotationally symmetrical load bearing element 30 being in force transferring contact with the plurality of blade bodies 22 in a load bearing section 28 located between the root section 24 and the tip section 26, to provide a secondary load path SLP for at least a part of reaction loads RL of the blade bodies 22,
wherein the blade bodies 22 of the rotor blades 20 are made of a composite material, comprising a polymeric matrix and continuous reinforcing fibres embedded in the polymeric matrix,
wherein the load bearing element 30 is made of a composite material, comprising a polymeric matrix and chopped reinforcing fibres embedded in the polymeric matrix.
Exemplary Embodiment 2. A rotor 10 according to exemplary embodiment 1, wherein the load bearing element 30 and the rotor blades 20 are formed as monolithic construction.
Exemplary Embodiment 3. A rotor 10 according to any of the preceding exemplary embodiments, wherein the polymeric matrix of the blade bodies 22 and the polymeric matrix of the load bearing element 30 are selected from the same group of material, in particular thermoplastics.
Exemplary Embodiment 4. A rotor 10 according to any of the preceding exemplary embodiments, wherein the load bearing element 30 comprises a primary load bearing part 32 in force transferring contact with the load bearing section 28 of the blade bodies 22 and a secondary load bearing part 34 in force transferring connection with the root section 24 of the blade bodies 22.
Exemplary Embodiment 5. A rotor 10 according to any of the preceding exemplary embodiments, wherein the load bearing element 30 at least partly extends in axial direction AD beyond the load bearing section 28 of the blade bodies 22.
Exemplary Embodiment 6. A rotor 10 according to any of the preceding exemplary embodiments, wherein the outer surface 31 of the load bearing element 30 comprises an aerodynamical functional shape.
Exemplary Embodiment 7. A rotor 10 according to exemplary embodiment 6, wherein the load bearing element 30 extends axially beyond the blade bodies 22, following a rotationally symmetrically curved shape creating a pointed nose 36.
Exemplary Embodiment 8. A rotor 10 according to any of the preceding exemplary embodiments, wherein the load bearing element 30 provides a hollow cavity 38.
Exemplary Embodiment 9. A rotor 10 according to any of the preceding exemplary embodiments, wherein the blade bodies 22 extent between the root section 24 and the load bearing section 28 in a linear or substantially linear manner.
Exemplary Embodiment 10. A rotor 10 according to any of the preceding exemplary embodiments, wherein the load bearing section 28 of the blade bodies 22 comprises a contact surface 29 extending at least partly along an axial direction AD of the rotor 10.
Exemplary Embodiment 11. A rotor 10 according to any of the preceding exemplary embodiments, wherein the load bearing element 30 comprises rounded edges at least at contact sections to the blade bodies 22.
Exemplary Embodiment 12. A rotor 10 according to any of the preceding exemplary embodiments, wherein the rotor 10 comprises at least one of the following geometric dimensions:
radial extension of the load bearing section 28 compared to the overall radial extension of the blade body 22 between 20% and 50%,
radial distance between the load bearing section 28 and the root section 24 of the blade bodies 22 between 20 mm and 50 mm,
radial distance between the load bearing section 28 and the tip section 26 of the blade bodies 22 between 100 mm and 150 mm,
radial extension of the blade body 22 between 20 mm and 1550 mm,
number of rotor blades 20 between 3 and 35.
Exemplary Embodiment 13. A method of forming a rotor 10 with the features according to any of exemplary embodiments 1 to 12, comprising the following steps:
molding a composite material comprising a polymeric matrix and continuous reinforcing fibres into a cavity forming a rotor blade 20 having a blade body 22 with a root section 24 to be connected to a drive shaft 110 to receive a primary driving load DL and a tip section 26 at the opposite end of the blade body 22,
arranging a plurality of such rotor blades 20 into a rotor mold 220,
molding a composite material comprising a polymeric matrix and chopped reinforcing fibres into a cavity forming a load bearing element 30, wherein such load bearing element 30 is formed in force transferring contact with the plurality of blade bodies 22 in a load bearing section 28 located between the root section 24 and the tip section 26, to provide a secondary load path SLP for at least a part of reaction loads RL of the blade bodies 22.
Exemplary Embodiment 14. The method according to exemplary embodiment 13, wherein for both molding steps and injection molding process is used.
Exemplary Embodiment 15. The method according to any of exemplary embodiments 13 or 14, wherein during the second molding step the molding temperature of the polymeric matrix of the load bearing element 30 is set at or above the melting temperature of the polymeric matrix material of the blade bodies 22.

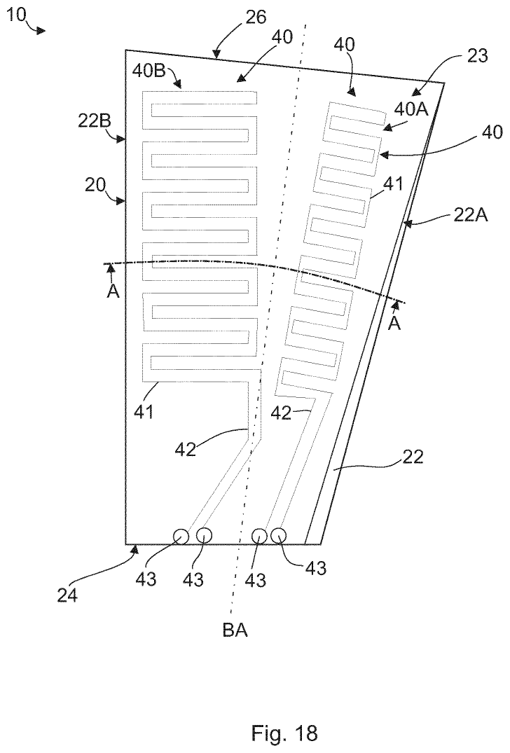

In the following, further aspects of the present disclosure are discussed with reference to FIGS. 18 to 23. These Figures show different views, aspects and embodiments of the disclosure. For instance, reference is made to an engine blade 20, which describes further aspects and embodiments of the rotor blade 20. Also, reference is made to an engine rotor 10, which describes further aspects and embodiments of the rotor 10.

In FIG. 18, an optional configuration of the engine blade 20 for the aircraft engine 100 is shown. The engine blade 20 extends longitudinally along a blade axis BA. The engine blade 20 comprises the blade body 22. The blade body 22 comprises a blade surface 23, which in operation, preferably exerts an accelerating force upon the air to be propelled. The blade surface 23 may extend circumferentially or in a chord-wise direction (e.g. illustrated by line A-A in FIG. 18) between lateral edges 22A, 22B. The lateral edges 22A, 22B may preferably represent a leading edge 22A and a trailing edge 22B, for instance during operation of the engine blade 20. The blade surface 23 may extend longitudinally or span-wise between the tip section 26 and the root section 24.

Generally, the blade body 22 may preferably comprise two or more heating elements 40 for heating different sections of the blade surface 23, namely first heating element 40A and second heating element 40B. As can be taken from FIG. 18, the heating element(s) 40 may be arranged anywhere between the tip section 26 and the root section 24 of the blade body 22. The heating elements 40 may be arranged side by side in a circumferential and/or longitudinal direction on the blade surface 23. The heating elements 40 may have an identical or different configuration. For instance, the heating elements 40 may be different in size, such as exemplarily illustrated in FIG. 18.

For example, the first heating element 40A may be arranged in the direction of the leading edge 22A. As exemplarily illustrated, the first heating element 40A may extend span-wise between the tip section 26 and the root section 24 along or parallel to the leading edge 22A. The first heating element 40A may be arranged proximal to the leading edge 22A. Preferably, the first heating element 40A may be configured and/or arranged such that it covers chord-wise between 0% to 20% of the blade surface 23. Alternatively or additionally, the first heating element 40A may be arranged such that it covers chord-wise a leading section of the blade surface 23, which extends preferably evenly from the leading edge 22A. Preferably, the leading section may be between 0% to 20% of the blade surface 23 or, between 0% to 20% of the blade surface 23 on one side of the engine blade 20. The one side may be the blade pressure side or blade pressure surface during operation.

Alternatively or additionally, the second heating element 40B may be arranged in the direction of the trailing ledge 22B. As exemplarily illustrated, the second heating element 40B may extend span-wise between the tip section 26 and the root section 24 along or parallel to the trailing edge 22B. The second heating element 40B may be arranged proximal to the trailing edge 22B. Preferably, the second heating element 40B may be configured and/or arranged such that it covers chord-wise between 20% to 100% of the blade surface 23. Alternatively or additionally, the second heating element 40B may be arranged such that it covers chord-wise a trailing section of the blade surface 23, which extends preferably evenly from the trailing edge 22B. Preferably, the trailing section may be between 20% to 100% of the blade surface 23. Alternatively, the trailing section may be between 20% to 100% of the blade surface 23 on one side of the engine blade 20.

Providing the heating functionality of the engine blade 20 with preferably two heating elements 40A, 40B may facilitate a preferable heating control method of heating the engine blade 20. For instance, the engine blade 20 may be heated in two stages. In a first stage, at least or only the first heating element 40A at the leading edge 22A may be operated. In a second stage, at least or only the second heating element 40B at the trailing edge 22B may be operated. For instance, a control device of the aircraft 100 may control the heating elements 40A, 40B based on icing conditions, such as outside conditions (e.g. ambient temperature and/or humidity) or other sensory indications regarding formation of ice on the engine blade 20. The control device may control the heating elements 40A, 40B such that the first stage is switched to the second stage based on at least one of the icing conditions exceeding an allowable threshold.

This control method and control arrangement is advantageous as the heating functionality is operated initially in areas of the engine blade 20, which are prone to icing, namely directly at the leading edge 22A and at the blade pressure side due to direct impingement with air. Other regions are heated in the second stage only if needed. Further, this ensures an energy efficient operation of the heating elements 40A, 40B. The proposed method is also advantageous as it leads to optimum de-icing and/or anti-icing properties of the engine blade 20 while at the same time it is ensured that the required properties regarding aeroelasticity and lightweight are maintained.

Alternatively or additionally, it is also conceivable to provide and arrange the heating elements 40, 40A, 40B in a span-wise direction (instead of the chord-wise arrangement illustrated in FIG. 18). Thus, the heating elements 40A, 40B may be arranged one after the other in the longitudinal direction (e.g. along the blade axis BA). Preferably, only the tip section 26 may remain uncovered from the heating element(s) 40, 40A, 40B. Thereby, regions of the blade surface 23, such as the blade pressure side and leading edge 22A, can be provided with heating functionality, which are prone for ice formation.

Naturally, it is also conceivable to implement such heating functionality with more than two heating elements 40, 40A, 40B. Also, configurations with only a single heating element 40 are conceivable. The single heating element 40 may cover a certain area of the blade surface 23 and may comprise controllable sections to be supplied selectively with energy. Thus, it is further conceivable that a heating control system may be formed by the heating blade 20 with one of these configurations, and a control device that is configured to implement the above described heating method.

The heating element(s) 40 exemplarily shown may comprise heat transfer conduits 41. These may be preferably electrically conductive and may extend along a wounded extension path with the blade surface 23. Preferably, connection sections 43, such as electrical connectors for supplying electrical power to the heating elements 40, may be provided at the root section 24. Feed lines 42 may connect the heat transfer conduits 41 with the connection sections 43.

The heating element 40 is provided integral with the blade body 22 within the blade surface 23. For this, the heating elements 40 may be provided on the blade body 22 in an additive manufacturing method, such as 3D-printing.

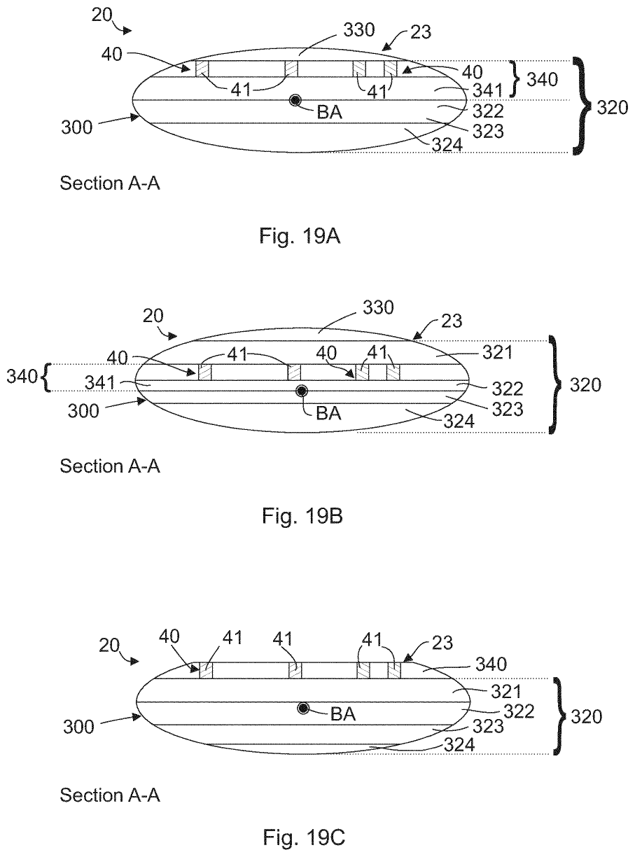

FIGS. 19A to 19C exemplarily illustrate this aspect of the engine blade 20. Therein, it is exemplarily shown that the blade body 22 comprises a layered structure 300, which comprises a base layer 320 and a heating layer 340. The heating layer 340 comprises the heating elements 40, which are indicated by the heat transfer conduits 41. The base layer 320 is provided for transmitting a driving force from the drive shaft 110 to the tip section 26 via the root section 24.

As exemplarily illustrated in FIGS. 19A to 19C, the base layer 320 may comprise several base support layers 321-324. These may be different components of a composite material, such as reinforcing fibres and a polymer matrix.

Various configurations and arrangements of the different layers of the layered structure 300 are conceivable, as exemplified by FIGS. 19A to 19C.

For instance, in FIG. 19A the heating layer 340 comprises a carrier layer 341, on which the heating elements 40 are integrally provided. As exemplarily illustrated, the heat transfer conduits 41 may be printed on the carrier layer 341. The heating layer 340 is arranged on one of the base support layers 322-324, namely the base support layer 322. Therein, the heating layer 340 is integrally bound via the carrier layer 341 to the base layer 320 by material bonding, such as through molding or curing. Further, the heating elements 40 are protected by a cover layer 330 that covers the heating layer 340 on an opposite side to the base support layer 322. The blade surface 23 is at least partially formed by the cover layer 330 and thus, the heating elements 40 are provided below the blade surface 23.

Further, in FIG. 19B the heating layer 340 comprises also a carrier layer 341, on which the heating elements 40 are printed. Unlike in FIG. 19A, the carrier layer 341 is formed by the base support layer 322. The heating layer 340 is arranged between the other base support layers 321, 323, and 324. Thus, the heating layer 340 forms an integral part of the base layer 320 in this example, since it forms a layer of the base layer 320.

FIG. 19C shows another example of the engine blade 20. Therein, the heating elements 40, or more specifically the heat transfer conduits 41, are printed directly on the base layer 320. Thus, in this example, the heating layer 340 does not comprise a carrier layer. The heat transfer conduits 41 may be provided as micro-structures so no filling material, such as resin, may be required to provide structural support between the heat transfer conduits 41.

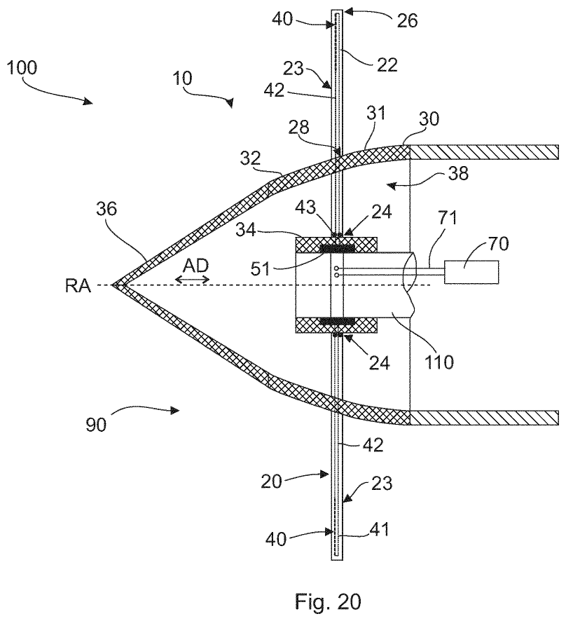

FIG. 20 exemplarily shows a cross-section of the engine rotor 10 and sections of the propulsion unit 4, 5 with said engine rotor 10. In this example, the engine rotor 10 comprises an agent supply device 51 for supplying electric power to the heating element 40 via the connection sections 43. In particular, the agent supply device 51 is provided as a slip ring 51. For example, supply lines 71 may be used to supply electric power from a control unit 70 to the slip ring 51. In the illustrated example, the slip ring 51 is integrally provided with the engine rotor 10. Further, the slip ring 51 is arranged coaxially with the rotation axis RA and radially inwards from the root section 24 with respect to the blade axis BA. The slip ring 51 is arranged relatively movable to an engine housing 120 (cf. FIG. 21) and preferably the drive shaft 110.

It is also conceivable to arrange the slip ring 51 on various other locations, such as laterally of the hub device 34 (previously referred to as secondary loadbearing part 34) with respect to the rotation axis RA.

FIG. 21 shows a cross-section of a further example of the engine rotor 10 and sections of the propulsion unit 4, 5. Therein, the agent supply device 52 is provided as an inductive supply device 52 to supply wirelessly, preferably inductively, electric energy to the heating element 40. The energy transmission is exemplarily illustrated by arrows with dashed lines. As shown in FIG. 21, the engine housing 120 comprises the inductive supply device 52. The inductive supply device 52 may be arranged at an upstream or downstream section of the engine duct. Further, the inductive supply device 52 may preferably arranged upstream of the engine blade 20, however, as illustrated, a downstream configuration is also conceivable. In this example, the heating element 40 may be correspondingly provided as an electric resonant circuit 45 to interact with the inductive supply device 52.

Generally, the agent supply device 51, 52 may be able or configured to supply any type of energy suitable for the heating element 40 to de-ice the blade surface 23. For instance, the agent supply device 51, 52 may supply a hot gas or heat to the heating element 40. Further, the agent supply device 51, 52 may be connected to an energy supply source, such as a solar panel or the control unit 70.

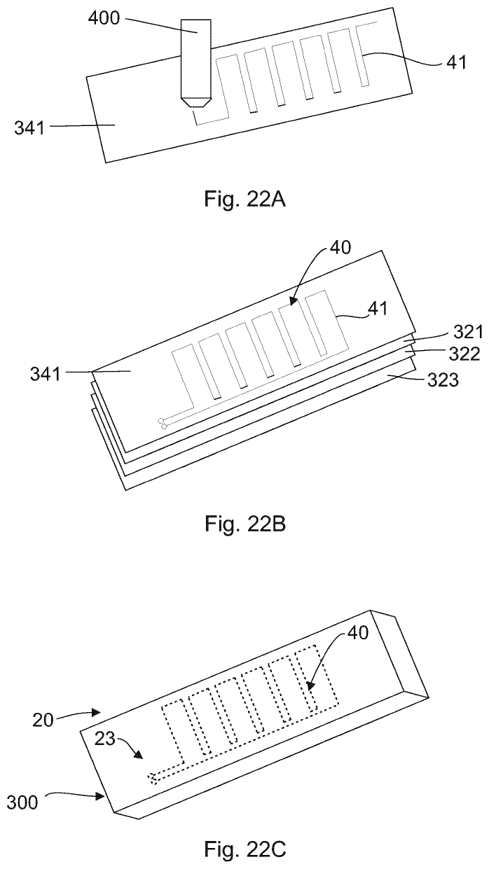

FIGS. 22A to 22C show exemplarily different steps of manufacturing said engine blade 20. In FIG. 22A, the heating element 40 is provided by printing a heat transfer conduit 41 on an uncured composite material layer as the carrier layer 341. For this, additive manufacturing device 400, such as a print head, may be used. Further composite layers 321, 322, 323 are provided and preferably cut to size for the engine blade 20. Other layers, such as the cover layer 330 may be provided, naturally. As shown in FIG. 22B, the different composite layers 321, 322, 323, 341 are stacked. FIG. 22C shows the different composite layers 321, 322, 323, 341 joint forming the integral engine blade 20.

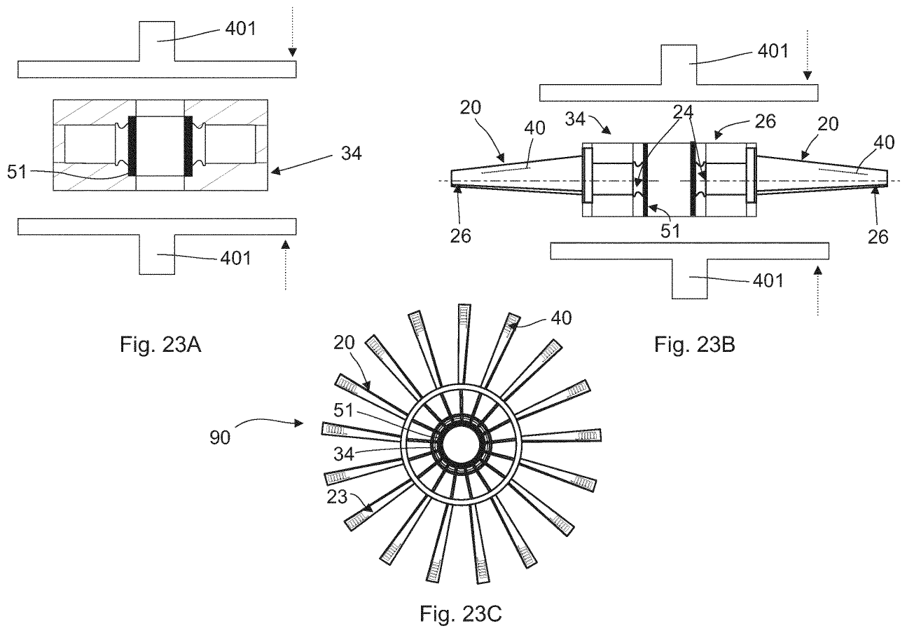

FIGS. 23A to 23C show different steps of a method of manufacturing an integral engine rotor assembly 90 (such as also illustrated in FIGS. 20 and 21). In FIG. 23A, the hub device 34 for receiving and supporting the root sections 24 of the engine blades 20 may be formed by compressing the respective materials. For instance, polymeric matrix and chopped reinforcing fibres embedded in the polymeric matrix may be used for this purpose. FIG. 23B shows how a plurality of the engine blades 20 are provided and arranged with respect to the hub device 34. In addition, the slip ring 51 may be provided and arranged at this stage or already in the step of forming the hub device 34. To form the integral engine rotor assembly 90, the engine blades 20, the hub device 34 and preferably the slip ring 51 are joined by injection molding or composite pressing (exemplarily indicated by pressing elements 401). Also, processing in an autoclave may be considered.

The disclosure is not limited by the embodiments as described hereinabove, as long as being covered by the appended claims. All the features of the embodiments described hereinabove can be combined in any possible way and be provided interchangeably.

### Reference signs

1 aerial vehicle
2 airfoil
2a left airfoil
2b right airfoil
3 fuselage
4 propulsion units
5 propulsion units
6a left canard
6b right canard
10 rotor, engine rotor
20 rotor blade, engine blade
22 blade body
22A leading edge
22B trailing edge
23 blade surface
24 root section
26 tip section
28 load bearing section
29 contact surface
30 load bearing element
31 outer surface
32 primary load bearing part
34 secondary load bearing part, hub device
36 pointed nose
38 hollow cavity
40 heating element
40A first heating element
40B second heating element
41 heat transfer conduit
42 feed lines
43 connection sections
45 electric resonant circuit
51 slip ring
52 inductive supply device
70 control unit
71 supply line
90 rotor engine assembly
100 fan engine
110 drive shaft
210 blade mold
220 rotor mold
300 layered structure
320 base layer
321-324 base support layer
330 cover layer
340 heating layer
341 carrier layer
400 additive manufacturing device
401 pressing element
CL centrifugal load
AL air load
RL reaction load
SLP secondary load path
RD radial direction
AD axial direction
BA blade axis
RA rotation axis

1. An engine blade for an aircraft engine, the engine blade comprising
a blade body comprising:
a blade surface, and
a heating element configured to heat at least a section of the blade surface, wherein the heating element is provided integral with the blade body within the blade surface.

2. The engine blade of claim 1, wherein the heating element comprises at least one heat transfer conduit, wherein (i) the heat transfer conduit is electrically conductive, (ii) the heat transfer conduit extends along a wounded extension path (iii) the heat transfer conduit extends along the blade surface, (iv) the heating element is provided on a section of the blade body in an additive manufacturing method, or any combination of (i)-(iv).

3. The engine blade of claim 1, wherein the blade body comprises a layered composite structure comprising:
a base layer configured to transmit a driving force; and
a heating layer that comprises the heating element
wherein the heating layer is arranged between the base layer and a cover layer that covers the heating layer on an opposite side to the base layer.

4. The engine blade of claim 3, wherein the heating layer (340) comprises:
a carrier layer, wherein the carrier layer is one of a foil and a film; and
the heating element wherein the heating element is integrally provided on the carrier layer,
wherein the heating layer is integrally bound via the carrier layer to the base layer by material bonding.

5. The engine blade of claim 3, wherein the heating layer forms an integral part of the base layer,
wherein the base layer comprises at least two base support layers wherein the heating layer is arranged between the at least two base support layers, or the heating layer is arranged on one of the at least two base support layers, and
wherein the carrier layer is one of the base support.

6. The engine blade of claim 1, wherein (i) the blade body is made of a composite material, comprising a polymeric matrix and continuous reinforcing fibres embedded in the polymeric matrix, (ii) the heating element is arranged between a tip section and a root section of the blade body, or (iii) both (i) and (ii).

7. The engine blade of claim 1, wherein
the heating element comprises connection sections for supplying a heat generating agent, wherein the heating element extends between a tip section of the blade body and a root section for attaching the engine blade to a drive shaft, wherein the connection sections are provided at the root section, and wherein the connection sections are electrical connectors.

8. An engine rotor (10) for propelling an aircraft (1), the engine rotor comprising at least one engine blade of claim 1.

9. A propulsion unit for propelling an aircraft, the propulsion unit comprising:
the engine rotor of claim 8; and
an engine housing with an engine duct, wherein the engine rotor is arranged rotatably about a rotation axis (RA).

10. The propulsion unit of claim 9, further comprising:
an agent supply device configured to supply a heat generating agent to the connection sections of the heating element, the agent supply device comprising:
an inductive supply device configured to inductively supply electric energy as the heat generating agent to the heating element wherein the engine housing comprises the inductive supply device, which is arranged,
at a section of the engine duct,
upstream of the engine blade, and
radially outwards from the engine blade, and
wherein the heating element is correspondingly provided as an electric resonant circuit to receive inductively electric energy from the inductive supply device (52), and/or
a slip ring configured to supply electric energy as the heat generating agent to the heating element, wherein the engine rotor comprises the slip ring, wherein the slip ring is integral with the engine rotor, wherein the slip ring is arranged relatively movable to the engine housing, and wherein the slip ring is arranged coaxially with the rotation axis (RA) and radially inwards from the root section.

11. A method of manufacturing an engine blade having a blade body with an integrated heating element configured to heat at least a section of a blade surface, the method comprising:
printing or depositing the heating element on the blade body (22); and
applying the heating element with a cover layer to form at least the heated section of the blade surface.

12. A method of manufacturing an engine blade having a blade body with an integrated heating element for heating at least a section of a blade surface, the method comprising:
providing composite layers for the engine blade;
providing and applying the heating element on at least one of the composite layers;
stacking the composite layers for the engine blade; and
joining the composite layers to form the engine blade.

13. The method of claim 12, wherein providing and applying the heating element comprises, before the stacking,
printing the heating element on at least a section of said composite layer,
printing at least one electrically conducting heat transfer conduit directly onto said composite layer,
arranging and curing the heating element with the carrier layer on at least a section of said composite layer,
arranging and bonding the heating element with the carrier layer on at least a section of said composite layer, said composite layer being an uncured layer.

14. The method of claim 12 wherein joining the composite layers comprises (i) injection molding, (ii) composite pressing, (iii) curing, (iv) bonding, or (v) any combination of (i)-(iv).

15. A method of manufacturing an integral engine rotor assembly, wherein at least one of the engine blades is manufactured by the method according to claim 11, the method comprising:
providing a plurality of engine blades, the engine blades comprising a blade body with a blade surface (23);
providing a hub device for receiving and supporting root sections of the engine blades (20),
arranging the engine blades and the hub device to form an engine rotor assembly; and
joining the engine blades and the hub device to form the integral engine rotor assembly.

16. The method of claim 15, wherein the joining the engine blades and the hub device comprises (i) injection molding, (ii) composite pressing, (iii) curing, (iv) bonding, or (v) any combination of (i)-(iv).

17. The method of claim 15, wherein the providing the hub device comprises forming the hub device, wherein the hub device is from a composite material, comprising a polymeric matrix and chopped reinforcing fibres embedded in the polymeric matrix, by compressing or injection molding, and wherein the step of forming the hub device comprises providing and arranging at the hub device an agent supply device for supplying a heat generating agent to the heating element, in order to provide the agent supply device integral with the hub device.
